(19) United States
(12) Patent Application Publication
(10) Pub. No.: US 2012/0104660 A1
(43) Pub. Date: May 3, 2012

(54) INJECTION MOLDING OF MICRON AND NANO SCALE FEATURES FOR PHARMACEUTICAL BRAND PROTECTION

(75) Inventors: Sandeep DISAWAL, Aurora, IL (US); Bjoern ROSNER, Chicago, IL (US); Patrick EISWERTH, Chicago, IL (US); Michael R. NELSON, Libertyville, IL (US); Robert JANOSKY, Naples, FL (US); Bo HE, Schaumburg, IL (US)

(73) Assignee: Nanolnk, Inc.

(21) Appl. No.: 13/284,727

(22) Filed: Oct. 28, 2011

Related U.S. Application Data
(60) Provisional application No. 61/408,539, filed on Oct. 29, 2010.

(51) Int. Cl. B29C 59/16; B29C 45/26; B29C 45/76; B29C 45/00; B29C 41/42

(52) U.S. Cl. 264/494; 264/328.1; 264/129; 264/40.1; 425/542; 425/577

(57) ABSTRACT

A method for forming a pharmaceutical container portion comprises providing a pharmaceutical container portion mold comprising a surface with at least one identification region, the at least one identification region comprising at least one identification feature that has a lateral dimension of 100 microns or less; and molding a pharmaceutical container portion from a moldable material using the mold, such that the at least one identification region is transferred to a surface of the pharmaceutical container portion. Applications include anti-counterfeiting.

### RELATED APPLICATIONS

This application claims priority to U.S. provisional application Ser. No. 61/408,539 filed Oct. 29, 2010, which is hereby incorporated by reference in its entirety.

### BACKGROUND

Estimates suggest that hundreds of billions of dollars a year are lost on counterfeit goods of one sort or another. Technology to prevent this should be difficult to replicate or simulate; difficult to alter, transpose, or tamper; easily recognizable by user in either overt or covert form; verifiable by manufacturer or issuer; easily applicable to product or document; and cost effective. Durability and flexibility in the technological goods are important.

A review of counterfeiting in pharmaceuticals and its economic effects may be found in, for example, (1) “Counterfeit Pharmaceuticals: Current Status and Future Projections,” A. I. Wertheimer, et al. J. Am. Pharm. Assoc. 43(6) 710-718 (2003), and (2) Chapter 4 of the book Counterfeiting exposed: protecting your brand and your customers, D. M. Hopkins, L. T. Kontnik, M. T. Turnage (Wiley, Ed. 2003); ISBN: 0471269905.

### SUMMARY

Exemplary embodiments are summarized in this non-limiting summary section.

In one aspect, a method is provided comprising providing a pharmaceutical container portion mold comprising a surface with at least one identification region, the at least one identification region comprising at least one identification feature that has a lateral dimension of 100 microns or less; and molding a pharmaceutical container portion from a moldable material using the mold, such that the at least one identification region is transferred to a surface of the pharmaceutical container portion.

In one embodiment, the mold comprises a receptacle and a removable insert, wherein the removable insert is configured to fit in the receptacle, and wherein the removable insert comprises the at least one first surface.

In one embodiment, the at least one first feature has a first height dimension smaller than about 100 microns. The at least one first feature can have a first height dimension smaller than about one micron. The first lateral dimension can be smaller than about one micron.

In one embodiment, the at least one first feature comprises at least one indentation into said at least one first surface. In another embodiment, the at least one first feature comprises at least one protrusion out of said at least one first surface.

In one embodiment, the at least one first feature comprises at least one bar code.

In one embodiment, the moldable material comprises a polymer.

In one embodiment, the pharmaceutical container portion comprises at least one of a vial cap or a syringe portion. The syringe portion can be, for example, the syringe barrel or the syringe plunger.

In one embodiment, the mold comprises a removable insert, the removable insert comprises the at least one first surface, and the method further comprises replacing the insert.

In one embodiment, the first and second features are nanoscale features.

In one embodiment, the first and second features comprise a covert feature or an overt feature.

In another aspect, a mold is provided for injection molding at least a pharmaceutical container portion, wherein said template comprises at least one surface, wherein said at least one surface comprises at least one integral feature with a lateral dimension smaller than about 100 microns.

In one embodiment, the pharmaceutical container portion comprises one of a vial cap, a bottle, or a syringe.

In one embodiment, the at least one surface is the interior of a vial cap, or bottle, or a syringe.

In one embodiment, the at least one integral feature is a nanoscale feature.

In one embodiment, the at least one integral feature comprises at least one indentation into said at least one surface.

In one embodiment, the at least one integral feature comprises at least one protrusion out of said at least one surface.

In one embodiment, the at least one integral feature comprises at least one bar code.

In one embodiment, the at least one integral feature comprises at least one optically variable device.

In one embodiment, the at least one surface is a surface of a replaceable insert.

In one embodiment, the at least one surface is a surface of a replaceable insert, and wherein said insert is disposed over a side wall or a bottom of said template.

In one embodiment, the mold further comprises a receptacle, wherein said at least one surface is a surface of a replaceable insert, and wherein said insert is configured to be removably coupled to said receptacle.

In another aspect, an insert is provided for a mold for injection molding at least a pharmaceutical container portion, the insert comprising at least one surface, wherein said at least one surface comprises at least one integral feature with a lateral dimension smaller than about 100 microns.

In one embodiment, the integral feature comprises a nanoscale feature.

In one embodiment, the integral feature comprises an overt feature or a covert feature.

In another aspect, a method is provided comprising disposing an adhesive or epoxy material over a pharmaceutical container portion, wherein said pharmaceutical container portion comprises a nanoscale feature; curing said adhesive or epoxy material; and removing the cured adhesive or epoxy material from said pharmaceutical container portion to thereby form a replica having a reverse feature of said nanoscale feature.

In one embodiment, the method further comprises inspecting said reverse feature using optical or scanning electron microscopy imaging.

In one embodiment, the curing comprises UV or thermal curing.

At least one advantage for at least one embodiment is that improved anti-counterfeiting can be achieved.

### BRIEF DESCRIPTION OF FIGURES

FIG. 1 shows a schematic diagram illustrating a template including an insert used as a mold for injection molding.

FIG. 2 shows an optical image of the covert feature on the adhesive surface.

FIG. 3 is a scanning electron microscopy (SEM) image of the covert logo on the adhesive surface showing features at, for example, a 50-100 micron scale.

FIG. 4 is an SEM image of the forensic feature (barcodes) on the adhesive surface.

### DETAILED DESCRIPTION

All references cited hereinafter are incorporated by reference in their entirety. No admission is made that any of the cited references is prior art.

Priority U.S. provisional application Ser. No. 61/408,539 filed Oct. 29, 2010 is hereby incorporated by reference in its entirety for all purposes.

A need exists to provide for better protection and security against counterfeiting and grey-market trading, particularly for pharmaceuticals. In particular, the technology hurdles become great when feature sizes go from a micro scale regime into a nanoscale regime such as below one micron, and in particular, below 100 nm. In recent years, some advances in lithography have been reported but these advances have not been applied to the identification problems noted above.

Embodiments described herein can be applied to a variety of products including pharmaceutical container portions such as vial caps and syringe components.

### Injection Molding

Injection molding is generally known in the art. For example, U-NICA Global Security Solutions has a technology known as IntraGRAM™ that forms holographic images in plastic parts.

References on stamping and molding include: (i) Harmening Bacher Bley et al. Proceedings IEEE Micro Electro Mechanical Systems 202 (1992), (ii) “Molding of Plastic Components Using Micro-Dem Tools”, Electronics Manufacturing Technology Symposium, Hong Li and Stephen D. Senturia, 1992, pp. 145-149, and (iii) I. Rubin Injection Molding (Wiley, N.Y) 1992.

One embodiment described herein is a method to form micro and nano scale structures in moldable materials such as polymer materials during the process of injection molding. The molded polymer parts may be items, such as, containers, portions of the containers, pharmaceutical vial caps or disposable syringe components.

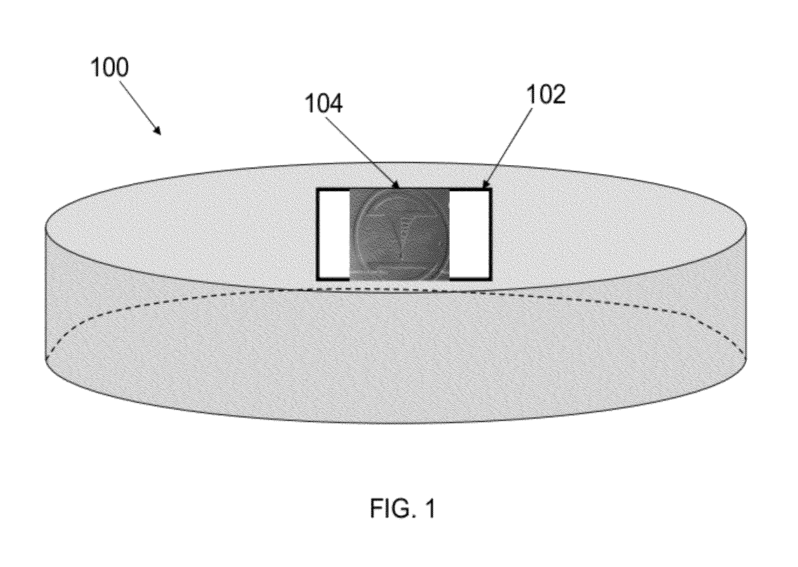

In one embodiment, as illustrated in FIG. 1, a template or mold 100 can include an insert 102 that has micro and nanoscale relief features 104. The insert 102 can be placed at a desired location of the mold 100, such as the side wall, a bottom, an exterior surface, or an interior surface. In some other embodiments, the micro and nanoscale relief features 104 can be formed directly on the mold, such as on a side wall, a bottom, an exterior surface, or an interior surface.

Polymer or other moldable materials can be disposed in the mold 100 during the molding process, such as by injection molding, and the features are formed into the polymer material surface. The molded features can include optically visible identification features, and forensic or sub-optical codes (such as barcodes) that contain alphanumeric data which may be linked to a database of information about the molded component. Information can thereby be imparted to a molded product through the surface structure of the molded product. These features provide strong brand authentication and information for tracking the product in the supply chain. In one embodiment, the features are nanoscale features, and the molded product is referred to as nanoencrypted product.

Nanoencryption may be integrated into existing injection-molded products with existing polymer constituents with few or no changes to the injection molding process conditions. If changes to the injection molding process are required, they would be minor. For example, parameters that may require adjustment include use of a higher plastic temperature, longer cool-down time, and/or higher packing pressure.

Also disclosed herein is a method to fabricate a replica containing a reverse structure of the molded feature for product authentication. A UV-curable adhesive was used as the replica material. Overt, covert and forensic features can be transferred to the adhesive surface upon contact with the nanoencrypted product surface. The described method is fast and does not require destruction/waste of the product which in many cases may be expensive. It also does not require the use of elevated temperature (to cure the adhesive) which may be detrimental to many biological reagents.

The assignee of the present application has developed several methods for forming micro and nanoscale features in pharmaceutical dosage units and drug container components. For example, the Nanoencryption process hot embosses structures onto the surfaces of tablets and capsules. This technique is also applicable to a range of polymer materials including those that are normally used in flip-off vial caps and disposable syringe components.

U.S. patent application Ser. No. 12/839,327 (Nano-molding Micron and Nano Scale Features; filed Jul. 19, 2010) describes means to mold features directly into gelatin capsules as they are formed by dipping metal pins in molten gelatin solution, the disclosure of which is hereby incorporated by reference in its entirety. Feature formation can be integrated into the process of forming gelatin capsule shells wherein the capsule forming pins can bear micro and/or nano structures that will get patterned to capsule surface during gelation.

Imprinting methods with stamps and methods of preparing the nanoscale features are described in, for example, U.S. patent application Ser. Nos. 11/109,877 filed Apr. 20, 2005; 11/305,327 filed Dec. 19, 2005; 11/305,189 filed Dec. 19, 2005; and 11/305,326 filed Dec. 19, 2005. See also U.S. Patent Application Pub. No. 2010/0046825.

Embodiments disclosed herein provide other means of forming features into the end product during the normal manufacturing process. For example, the features are formed in the polymer material of the vial cap or syringe portions as the part is injection molded. The syringe portions include, for example, syringe barrels or syringe plungers. This has advantages in terms of cost and throughput by molding during manufacturing as opposed to embossing on the finished part. These features can be used in pharmaceutical brand protection in terms of product authentication and tracking of goods in the supply chain.

### Surface Features

The surface of the pharmaceutical container portions can be an exterior surface or an interior surface. The surface of the container portions can be generally smooth, although at the scale of the identification features described herein the surface can be generally rougher. The surface can be non-flat or curved, including spherical, oval, or bi-convex. An interior surface can be desirable to avoid scratching or rubbing of the identification region.

The identification region may comprise one or more features, which protect the information-bearing part from erasure or damage. For example, a raised ring or frame surrounding the identification features may avoid mechanical abrasion of the identification.

The surface of the container portions can comprise non-identification regions and one or more identification regions. An identification region can be an area which is different from the non-identification regions and can have, for example, features for identification (identification features) which are not present in the non-identification regions. Examples of identification regions include bar codes, including for example one-dimensional or two-dimensional bar codes, optionally conforming to the standards of the Uniform Code Council. Other examples include text, symbols, moiré patterns and other engineered patterns that can be clearly interpreted.

In many cases, a full inspection of the identification region may be needed to make the identification. In other words, only inspecting some of the identification features may not give sufficient information to provide adequate identification. For example, if a bar code identification region comprises a series of 10 lines, reading only five of the lines may not give the information needed. The identification region can be characterized by an identification region area which has an enclosing perimeter around the identification features so that all of the identification features can be found within the enclosing perimeter. This area can be for example, about 10,000 square microns or less, or about 1,000 square microns or less, or about 400 square microns or less, or about 4 square microns or less, or about one square micron or less. The identification region can be, for example a square region with a lateral length and width of 100 microns×100 microns, respectively, or 20 microns×20 microns, or 2 microns×2 microns. Or the identification region can be, for example, a generally rectangular region or circular region. In many cases, two or more identification regions are desired in case one or more of the identification regions become unreadable by scratching, rubbing, or some other undesirable event. For example, the surface can comprise more than 20, more than 30, more than 40, or more than 50 identification regions. The identification region can be sufficiently large to be seen by the naked eye or an optical microscope, even when identification features within the identification region can be sufficiently small that they cannot be seen by the naked eye or even with an optical microscope.

Identification generally can enable a recognition. Identification can be also a verification or an authentication. It can encompass both tracing and tracking as well as authentication, including both bar codes and moiré patterns for example.

The identification features are not particularly limited by any shape and can be, for example, dots, circles, lines, rectilinear structures, curvilinear structures, or bar codes, whether linear or radial. Other examples include geometric objects such as, for example, triangles or rectangles. The identification features can be space filling such as, for example, a disk or can be non-space filling such as, for example, a donut or circle with a hollowed out interior. The identification features can form moiré patterns and can be, for example, periodic arrays of lines or dots. The identification features can also form a trademark, service mark, or some other indicia of good will to the customer or branding mark. Dates, names, and other useful commercial information can be provided. In general, the identification features are not complex technological patterns such as a complex circuit pattern. Rather, in general, the function of the identification feature is for identification, not another utility. Generally, it is desired to make the feature as simple as possible while still retaining the function of being an identification feature. For example, bar code technology can be applied at this scale wherein, for example, the width, spacing, and length of lines, and ratios thereof, can be varied to provide information. Preferably, a plurality of identification features can be used and in many cases, only one identification feature is insufficient to provide the needed identification. Preferably, for example, a plurality of linear structures is used in a bar code format.

The identification features can be a positive structure with respect to the surface or a negative structure with respect to the surface. For example, a negative structure can be an indentation, whereas a positive structure can be a protrusion. Hence, for example, a line identification feature could be stamped into a surface to generate an indentation of the line, or a region of a surface could be stamped which resulted in a line protruding from the surface after stamping. Whether positive or negative, the identification feature should be durable and if a positive identification is not sufficiently durable, it can be converted to a negative identification feature.

In general, identification features are preferred which are durable over time. The identification regions and features can be characterized by dimensional measurements such as lateral dimensions or vertical dimensions with respect to the surface. Conventional methods can be used to measure these dimensions including methods described herein and the working examples. Conventional data processing including image processing, pattern recognition, curve fitting and optical character recognition (OCR) can be carried out to provide dimensions and average dimensions and generally to provide useful data.

The identification regions can each have one or more identification features which can be characterized by a lateral dimension with respect to the surface. The lateral dimension can be, for example, a width or a length such as, for example, a circle diameter or a line width, or the relative or absolute position compared to a known mark. The lateral dimension is different from a vertical dimension such as height. For an identification feature which is a line, the lateral dimension of length can be sufficiently long that it can be viewed with the naked eye or an optical microscope, whereas the lateral dimension which is width can be sufficiently small that it cannot be resolved with a naked eye or optical microscope. The size of the lateral dimensions can be sufficiently small so that the identification features are invisible to the naked eye and difficult to detect by conventional, simple methods. Rather, difficult, relatively expensive methods can be used to detect small identification features including microscopic and nanoscopic features. At least one of the lateral dimensions can be made small. For example, the identification feature can have a lateral dimension of, for example, about 500 microns or less, or about 400 microns or less, or about 300 microns or less, or more particularly, about 250 microns or less, or more particularly, about 100 microns or less, or more particularly, about 10 microns or less. Or the identification feature can have a lateral dimension of, for example, about one micron or less, or more particularly, about 500 nm or less, or more particularly, about 250 nm or less, or more particularly, about 100 nm or less. There is no particular limit to how small the lateral dimension can be as long as the identification feature can be detected. For example, the lateral dimension can be at least about 1 nm, or more particularly, at least about 10 nm, or more particularly, at least about 100 nm, or more particularly at least about one micron. Hence, exemplary ranges for the lateral dimension include about one nm to about 500 microns, about 10 nm to about 100 nm, about 100 nm to about one micron, and about one micron to about 500 microns.

For barcodes, the line length is not particularly limited but can vary from nanoscopic to microscopic. For example, lines can be about one micron to about 50 microns long, or about 5 microns to about 25 microns long, and yet have a line width of only about 50 nm to about 150 nm wide.

The identification features can be in the form of a pattern of repeating features such as dots or lines, wherein the features are characterized by an average lateral dimension such as average circle diameter or line width. The lateral size dimensions described herein can be computed into average lateral dimensions.

The identification features can have a vertical dimension such as a height dimension or a depth dimension, and these terms are used interchangeably and for both positive structures and negative structures. The height dimension is not particularly limited and can be, for example, about five microns or less, or about one micron or less, or more particularly, about 500 nm or less, or more particularly about 250 nm or less, or more particularly about 150 nm or less. There is no particular lower limit to the height dimension as long as the identification feature can be detected. The height dimension can be, for example, about one nm or more, or about 10 nm or more, or about 25 nm or more. Exemplary ranges can be, for example, about one nm to about one micron, or about 10 nm to about 500 nm, or about 25 nm to about 250 nm. Again, if a pattern of repeating identification features is used, the vertical dimension can represent an average dimension. The ratio of the depth to the width of the features can be less than 1.

In addition to the lateral dimension and the height dimension, the embodiments disclosed herein can be also characterized by a separation dimension which represents the distance between the identification features such as a separation distance or a pitch. In other words, the one or more identification features can be separated from each other by a particular distance, and this distance can be an average distance for an array of identification features. For example, if the identification features are a series of lines, a distance can be measured between the centers of the lines, or if the identification features are a series of dots, a distance can be measured between the centers of the dots. The distance of separation is not particularly limited but smaller separation distances are preferred so that the identification is invisible to the unaided eye. For example, the one or more identification features can be separated from each other by an average distance of about 500 microns or less, or more particularly, about 100 microns or less, or more particularly, about 10 microns or less, or more particularly, about one micron or less, or more particularly, about 500 nm or less.

### Inserts

An “insert” or a “pin” is a contraption (usually a mechanically robust part) suitable as a carrier for a nanostructured stamp or features and as a mechanical and thermal interface to a mold. Inserts can be used in injection molds to add variable information for a particular lot or batch of product without changing the design of the (usually costly) mold. Examples include serialization or date stamp inserts. In one embodiment, an insert is fabricated in a manner similar to the stamps used for Nanoencryption on the tablet and capsule machines. The insert will have a larger mechanical structure, such as a dieholder, with an embossed die attached. The gate in the injection mold may be located such that the molded material flows over the die during injection, rather than hitting the die straight-on. This configuration allows the molded material to roll over features of the die without creating significant shear, which can dismount the die from the dieholder or cause damage to micro and nanoscale features on the die. Pressure on the features thus increases gradually as the mold cavity become filled and packed. The die may be located far from the gate in the mold (though preferably not on the weld line) and close to the air vents to improve replication quality. The die may extend into the mold cavity, such that the resulting molded product has a nanoencryption feature that is slightly recessed from the surrounding surface, resulting in increased abrasion resistance.

The die may be attached to the insert or pin using epoxy or other adhesives, or using clamps or retaining shims. The inserts or pins may have shallow cut-outs on their ends into which the die may be glued. This can allow for quick exchange of inserts or dies.

Shrinking of the molded product occurs after molding is complete and the product is cooled. In some embodiments, the molded product can easily demold from the die during shrinking such that it can be more easily removed from the mold.

The insert can be replaced for each manufacturing lot of parts that are injection molded. In this way, parts are patterned with micro and nanoscale features similar to those hot-embossed on tablets and capsules during Nanoencryption. All the benefits for brand protection associated with the assignee's tablet and capsules technology are in this way provided on the injection molded parts using the manufacturing process disclosed in the Applicants' prior patent applications.

The insert can be manufactured at low cost and readily exchanged in the molds for batch-level addition of micro and nano scale features. Features at micro and nano length scale are difficult to create and thus provide strong product authentication. Nanoscale features encode alphanumeric information that can be linked to a database of information about the product. Nanoscale codes can be used to track product in the supply chain for purposes of combating counterfeiting and illegal diversion of drugs.

### Replica

The described method can be applied to the situation when the product cannot be directly used for authentication, such as a large size syringe or an expensive vial. Also, some materials/containers, including those that contain liquids, may not be compatible with the vacuum chamber on the SEM which is used for authentication. A replica containing the reverse structures of the molded features on the product can be fabricated for authentication purpose. Epoxy/adhesives are commonly used materials, most of which require elevated temperature for curing. The replica material includes a wide range of UV and thermal curable materials if applicable.

### Pharmaceutical Container Portion

One embodiment of the product is a pharmaceutical container, and pharmaceutical containers are known in the art for a variety of uses, such as holding pharmaceutical capsules or pills. They should also be durable and stable during transport and storage.

The container can be a bottle, a cap, a syringe, etc. The container components can be a side wall, a bottom, or other portions of the container. Security features can be added on vial caps, syringe components and other injection molded components during manufacturing. This is particularly important for the identification of the pharmaceutical content stored in the container.

### Moldable Materials

The methods disclosed herein are applicable to a wide range of polymer materials and injection molded parts. In some embodiments, container components comprise polymer or other moldable materials. Examples of polymers that can be used include polypropylene (including homopolymer type polypropylene), polyethylene (LDPE and HDPE), and polycarbonate. Glass-packed polymers may be used. For storing capsules that are used in a human or animal, the materials for the container should comply with applicable government regulations and not injure the host.

### Templates and Copies

In some embodiments, moldable materials are injected into cavities of templates and allowed to mold. The type of template used will generally depend on the type of injection molding employed. The resulting pharmaceutical container may be referred to as a copy. In some embodiments, the copies are container portions or components.

Molding pins are exemplary of templates used in dip coating. Molding pins suitable for use in a gelatin capsule dip coating process are disclosed in U.S. Pat. No. 4,758,149, which is incorporated by reference in its entirety.

Another example of a template is a mold, such as those used in such molding processes as casting, extrusion blow molding, stretch blow molding, injection molding, and the like. As will be clear to those skilled in the art, many other types of objects could be used as templates.

Template surfaces may be characterized as being substantially convex or substantially concave. An example of a substantially convex template surface is the outward-facing surface of a casting mold. On the other hand, an example of a substantially concave template surface is the inward-facing surface of a casting mold.

The surface of the template may be made of a variety of materials. In general, the surface should be compatible with the moldable material used in the method. It is also desirable that the surface be harder and stiffer than the copy or container product. The surface material may optionally be treated to increase its hardness and durability, if desired. These considerations may be supplemented by others known to those skilled in the art.

Surfaces with Integral Features

In some embodiments, container portions may have surfaces with integral features. “Integral features” refer to features consisting of the container component material itself, rather than being other applied materials, such as inks or taggants. In will be appreciated by those skilled in the art that by avoiding the use of other materials, regulatory and fitness-for-use requirements may be more easily met. The integral feature can be characterized by an absence of an interface between the feature and the rest of the container portions.

Integral features may be either on an interior or exterior surface of container components.

Surfaces with Small Scale Features

In some embodiments, surfaces may have small scale features. Examples of such features are lines, dots, logos, bar-codes, and optically variable devices, including moiré patterns. A variety of methods may be used to prepare such features. Examples of such methods are described in, for example, U.S. application Ser. Nos. 11/109,877 (filed Apr. 20, 2005), as well as 11/305,327; 11/305,189 and 11/305,326 (all filed Dec. 19, 2005) and these are hereby incorporated by reference in their entireties.

Optically variable devices are described in Lee, R. A., “Optically Variable Devices”, Chapter 7 of Micromanufacturing for Document Security, Mahalik, N. P. ed., Springer, Berlin, 2006, which is incorporated by reference in its entirety.

In some cases, lithographic methods may be used, including scanning probe lithography (including DPN printing, nanografting, nanooxidation, and scanning tunneling methods), electron beam lithography, ion beam lithography, laser-based lithography, optical lithography, ultraviolet lithography, X-ray lithography, electron projection lithography, ion projection lithography, low energy electron proximity lithography, forms of lithography involving neutral atoms, grey-tone (relief) microlithography, and the like. Lithographic methods may optionally be used in combination with other processing methods, for example, wet or dry etching, lift-off, substrate doping (including ion implementation), layer deposition, electroplating, electroless plating, polishing, chemical mechanical polishing, and the like. Alternatively, a suitable object may be provided by replicating the features of another object by, for example, stamping, or by molding into a soft material that is subsequently hardened and treated by physical vapor deposition, electroless plating, electroplating, or a combination thereof. These methods may be supplemented by others known to those skilled in the art.

For templates, the surface so prepared may either be an integral part of the template or, optionally, be part of a removable insert that fits into a receptacle in the template or onto the template directly. Such a removable insert could enable the rapid changing of the surface used in the method, as might be required if the small scale features encoded such information as pharmaceutical lot numbers, product identifiers, manufacture dates, and the like.

Small scale features on the surface may be overt or covert. Overt features are those that are typically readily perceived by an observer without unusual technological assistance. Examples of overt features are described in U.S. application Ser. Nos. 11/109,877 filed Apr. 20, 2005, and 11/305,189 filed Dec. 19, 2005, both of which are incorporated by reference in their entireties. Such overt features may be used as means of authentication of objects or compositions of commercial value, such as pharmaceutical items. In such a case, it is preferable that the overt features be visually distinctive and of such a quality that they would be difficult for a counterfeiter to duplicate. Another possible use of such overt features would be to identify brands, models, pharmaceutical lot numbers, product identifiers, manufacture dates, doses, and the like.

Covert features are those that are typically difficult to detect, locate, or decode, especially with the naked eye or with conventional inspection technology, such as optical imaging. Examples of covert features are described in U.S. application Ser. Nos. 11/109,877 filed Apr. 20, 2005, and 11/305,326 filed Dec. 19, 2005, both of which are incorporated by reference in their entireties. Such covert features could enable detection of counterfeits without alerting counterfeiters of their presence. They might allow traceability of objects or compositions of commercial value, such as pharmaceutical items, by incorporating such information as pharmaceutical lot numbers, product identifiers, manufacture dates, and the like. Systems for detection of such covert features have been described in U.S. application Ser. No. 11/519,199 filed Sep. 12, 2006, which is incorporated by reference in its entirety.

Small scale features may be characterized by their dimensional measurements. One such dimensional measurement is the small scale feature's height, representing the feature's distance substantially above or below the surface. As used here, a feature's height is always a positive quantity, regardless of whether it lies above or below the surface. The height dimension is not particularly limited and can be, for example, about one micron or less, or more particularly, about 500 nm or less, or more particularly about 250 nm or less, or more particularly about 150 nm or less. There is no particular lower limit to the height dimension as long as the feature can be detected. The height dimension can be, for example, about one nm or more, or about 10 nm or more, or about 25 nm or more. Exemplary ranges can be, for example, about one nm to about one micron, or about 10 nm to about 500 nm, or about 25 nm to about 250 nm. If a pattern of repeating identification features is used, the height dimension can represent an average dimension.

Another such dimensional measurement is the small scale feature's lateral dimension, representing the feature's length or width substantially parallel to the surface. For a feature that is a line, the lateral dimension of length can be sufficiently long that the feature can be viewed with the naked eye or an optical microscope, whereas the lateral dimension of width can be sufficiently small that the feature cannot be so viewed. For applications requiring covert marks, one of these lateral dimensions can be made small. For example, the feature can have a lateral dimension of, for example, about 500 microns or less, or about 400 microns or less, or about 300 microns or less, or more particularly, about 250 microns or less, or more particularly, about 100 microns or less, or more particularly, about 10 microns or less. Or the feature can have a lateral dimension of, for example, about one micron or less, or more particularly, about 500 nm or less, or more particularly, about 250 nm or less, or more particularly, about 100 nm or less. There is no particular limit to how small the lateral dimension can be as long as the feature can be detected. For example, the lateral dimension can be at least about 1 nm, or more particularly, at least about 10 nm, or more particularly, at least about 100 nm, or more particularly at least about one micron. Hence, exemplary ranges for the lateral dimension include, for example, about one nm to about 500 microns, or about 10 nm to about 100 nm, or about 100 nm to about one micron, and about one micron to about 500 microns.

For barcodes, for example, the line length is not particularly limited but can vary from nanoscopic to microscopic. For example, lines can be about one micron to about 50 microns long, or about 5 microns to about 25 microns long, and yet have a line width of only about 50 nm to about 150 nm wide.

Where the small scale features are in the form of a pattern of repeating features, the features can be characterized by a lateral dimension representing an average lateral dimension such as an average circle diameter or an average line width.

Still another such dimensional measurement is the separation distance between small scale features or groups of small scale features. For example, if the features are a series of lines, a distance can be measured between the centers of the lines, or if the features are a series of dots, a distance can be measured between the centers of the dots. The distance of separation is not particularly limited, but smaller separation distances are preferred where it is desired that the features be covert. For example, one or more features can be separated from each other by an average distance of about 500 microns or less, or more particularly, about 100 microns or less, or more particularly, about 500 nm or less.

Yet still another such dimensional measurement is the size of the area of the smallest perimeter that could contain all of the members of a group of small scale features. This area can be, for example, about 10,000 square microns or less, or about 1,000 square microns or less, or about 400 square microns or less, or about 4 square microns or less, or about one square micron or less. Or the features can be, for example, in a square region with a lateral length and width of 100 microns×100 microns, or 20 microns×20 microns, or 2 microns×2 microns, or one micron×one micron. The groups need not, of course, be arranged in a square region. In general, the smallest perimeter might form a circle, a polygon, or some smooth or irregular closed shape.

As will be clear to those skilled in the art, it is possible for a surface to have many features that have a wide-range of dimensions. On can use one or more larger features in combination with one or more small scale features.

Fabrication Methods for the Mold with Micron or Nano Scale Features

E-beam direct-write lithography can be used to generate the microscopic or nanoscale features on the mold or insert. E-beam direct-write lithography is adapted to lithography at very high resolution and is flexible, since it does not require a mask. Electron Beam lithography equipment may be purchased from Raith Gmbh (Dortmund, Germany), Leica Microsystems Inc. (Chantilly, Va.) or JEOL USA (Peabody, Mass.). E-beam lithography services are available from Rockwell Scientific (Thousand Oaks, Calif.). Resists adapted to electron-beam lithography are commercially available, e.g., from Zeon Corp., Toray Corp. (both of Tokyo, Japan) and MicroChem (Newton, Mass.). Electron-beam lithography may be practiced with the help of the following literature, which are hereby incorporated by reference:
1) “Patterning of Material Layers in Submicron Region”, U. S. Tandon, W. S. Khokle, Wiley, Ed.; 1994.
2) A. N. Broers, J. M. Harper, and W. W. Molzen, Appl. Phys. Lett. 33, 392 (1978)
3) P. B. Fischer and S. Y. Chou, Appl. Phys. Lett. 62, 2989 (1993)
4) Y. Chen, A. Pepin, Electrophoresis 22, 187-207 (2001).

In addition, it is known in the art that stamps used in nanoimprint lithography and related techniques are usually fabricated using e-beam lithography, see e.g., “Template for room temperature, low pressure micro- and nano-imprint lithography”, U.S. Pat. No. 6,696,220 to Bailey et al. Electron-beam lithography techniques have been used to produce optically variable devices for use as anti-counterfeiting devices, see e.g., “Micro-technology for anti-counterfeiting”, Microelectronic engineering 53(1-4):513-516 (2000) and references herein.

Microfabrication techniques other than scanning probe lithography, electron-beam lithography and extreme UV lithography can be employed to prepare the features on the mold or insert. Lithographic methods under consideration include but are not limited to optical lithography (including immersion lithography, Deep Ultraviolet (DUV) lithography and Vacuum Ultraviolet (VUV) lithography), focused ion beam lithography (FIB), X-ray lithography, electron and ion projection lithography (EPL and IPL), including SCAPEL and PREVAIL, low energy electron proximity projection lithography (LEEPL), forms of lithography involving neutral atoms, and grey-tone (relief) microlithography.

The lithography step may be optionally combined with (i) one or more process steps including in a non-limiting way wet or dry etching, lift-off, substrate doping (including ion implementation), layer deposition, electroplating, electroless plating, (ii) zero or more planarization steps, including polishing, chemical mechanical polishing and overcoating with a thick layer. This includes processes such as Lithographie-Galvanoformung-Abformung (LIGA) and its optical lithography equivalent (UV-LIGA), see, e.g., “Microprocessing at the fingertips”, G. Thornell, S. Johnansson, J. Micromech. Microeng. 8, 251-262 (1998).

The following references may be used to practice the disclosed embodiments and are hereby incorporated by reference:
1) Lithographic imaging techniques, including optical lithography, particle beam lithography, EUV and X-ray have been reviewed by Wallraff and Hinsberg, “Lithographic Imaging Techniques for the formation of nanoscopic features”, G. M. Walraff, W. D. Hinsberg Chem. Rev. 99, 1801, 1999.
2) Nanolithographic techniques, including e-beam lithography, have been reviewed by Marrian et al., “Nanofabrication”, C. R. K. Marrian, D. M. Tennant J. Vac. Sci. Technol. A 21(5), 2003.

### Working Examples

The following example illustrates various embodiments of the claims. It is not intended to limit the scope of disclosure or claims.

### Experimental Procedures:

A flip-off vial cap is formed and Nanoencrypted using the injection molding method described above. Next, a thin layer of UV-curable adhesive (e.g., Norland Optical Adhesive 81) is applied on top of the patterned vial cap surface. The vial cap with the adhesive is exposed under a UV lamp (e.g., TL-D 15W BLB SLV) for 90 seconds, at a distance of about ½ inch. The cured adhesive is then peeled off from the vial cap. The reverse structures, as opposed to the features on the vial cap, are transferred to the adhesive surface. Optical and scanning electron microscope (SEM) imaging can then be used to authenticate the features on the adhesive surface.

### Experimental Results:

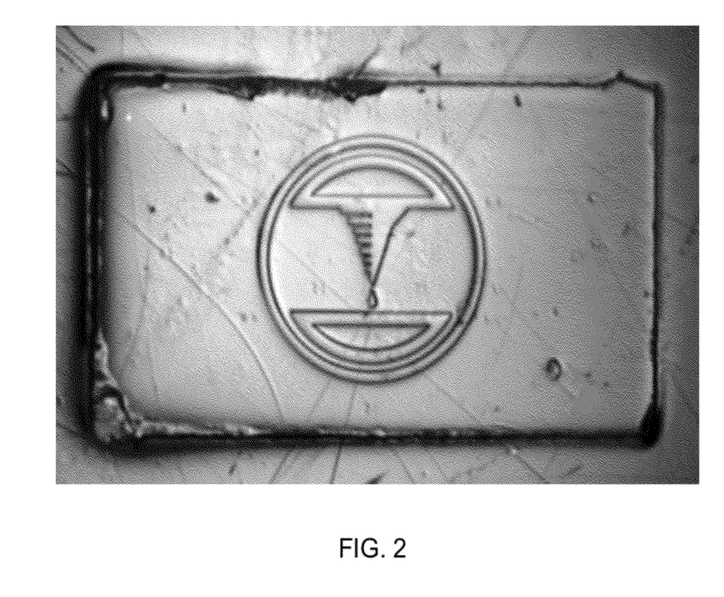

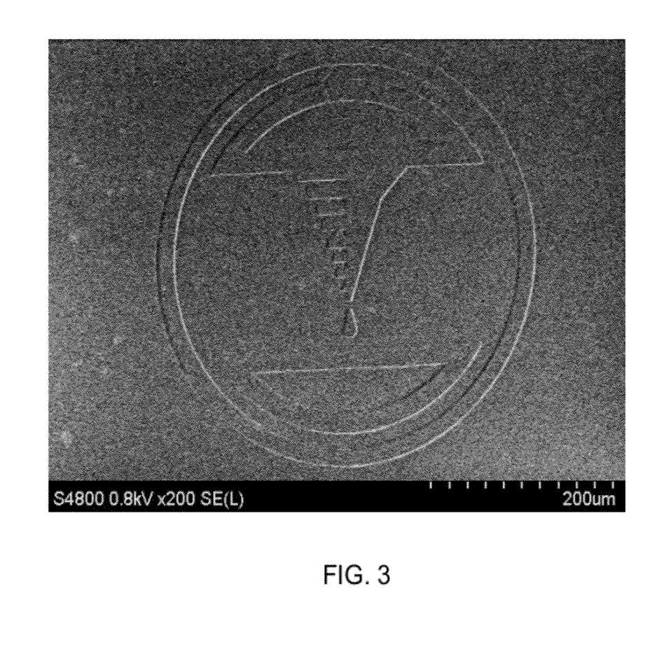

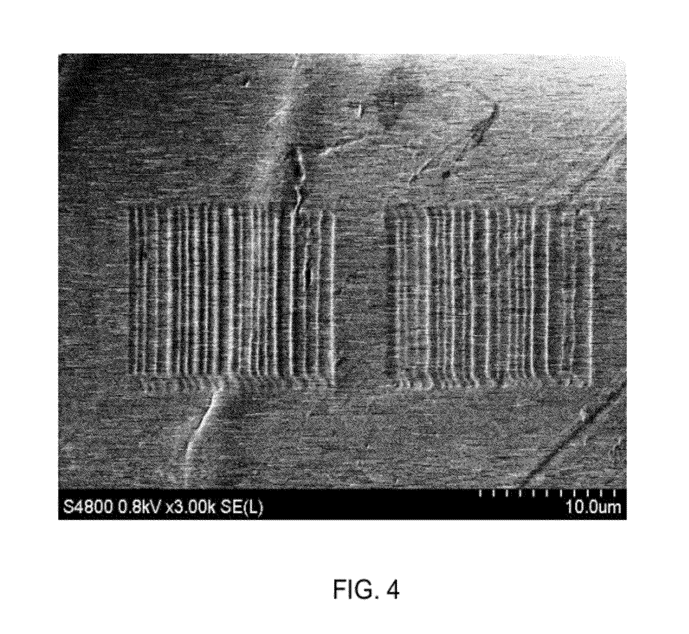

Using nanoencrypted vial cap containing both overt and covert features, the adhesive surface can have the reverse features as shown in the optical image of the covert feature as shown in FIG. 2, or the SEM image of the covert logo at, for example, a 50-100 micron scale, as shown in FIG. 3. FIG. 4 shows the SEM image of the forensic feature (barcodes) on the adhesive surface.

### Nano-Molding for Transparent Container Portions

Nano-molding can be performed on a container interior for transparent container components, which can have a visible inner surface. This can be very useful for anti-counterfeiting purposes. In one embodiment, only overt (logo) features are used that will be seen with a basic authentication kit. They can be protected from environmental effects.

Detection can be made using a reflected light, or light transmission if the container portion is transparent or disassembled.

Other Objects and Compositions with Identification Features

In general, the various embodiments disclosed herein can be applied to pharmaceutical goods which are susceptible to counterfeiting, including for example high priced pharmaceuticals, prescription drugs, and blockbuster drugs with large sales volume, wherein price differentials exist from country to country and the economic incentive to counterfeit is high, as described above. The description above for pharmaceutical container portions, and methods of making, generally can be also adapted to apply to other objects which can be subjected to counterfeiting fraud such as the confectionary compositions and consumer goods like CDs or DVDs.

Hence, the embodiments disclosed herein also relate to objects and compositions which have a surface, wherein the surface comprises at least one identification region having at least one identification feature. An object broadly can be a variety of items including items of commerce and is not particularly limited by any shape or form. It can be man-made or natural. Typically, an object can have a particular use or function and can comprise one or many compositions. A composition also broadly can be a variety of materials, chemical compounds, elements, mixtures, blends, composites, metals, glasses, polymers, ceramics, and the like and is not limited by a particular use or function. The identification feature on the object or composition can have relatively small lateral and vertical dimensions. The feature can be a positive feature, protruding from the surface, or a negative feature, extending into the surface.

Preferred examples of objects include consumer products, entertainment media, compact disks, DVDs, disk drive heads, semiconductor chips, integrated circuits and their components, and packaging containers. In particular, syringes, pre-loaded syringes, vaccines and vaccine vials, and injectable drug vials, including bottle seal, medical devices including catheters and implantable devices, and packaging labels can be used. In general, objects which are susceptible to counterfeiting or copying are particularly of use.

What is claimed is:

1. A method comprising:
providing a pharmaceutical container portion mold comprising a surface with at least one identification region, the at least one identification region comprising at least one identification feature that has a lateral dimension of 100 microns or less; and
injection molding a pharmaceutical container portion from a moldable material using the mold, such that the at least one identification region is transferred to a surface of the pharmaceutical container portion.

2. The method according to claim 1, wherein the mold comprises a removable insert, and wherein the removable insert comprises the surface with the at least one identification region.

3. The method according to claim 1, wherein the at least one identification comprises two or more identification regions.

4. The method according to claim 1, wherein the at least one identification feature has a height smaller than about 100 microns.

5. The method according to claim 1, wherein the at least one identification feature has a height smaller than about 1 micron.

6. The method according to claim 1, wherein the lateral dimension is smaller than about 1 micron.

7. The method according to claim 1, wherein the at least one identification feature comprises an indentation in the surface of the mold.

8. The method according to claim 1, wherein the at least one identification feature comprises a protrusion on the surface of the mold.

9. The method according to claim 1, wherein the at least one identification region comprises a barcode.

10. The method according to claim 1, wherein the at least one identification region comprises a moiré pattern.

11. The method according to claim 1, wherein the moldable material comprises a polymer.

12. The method according to claim 1, wherein the pharmaceutical container portion comprises a bottle, a vial cap, a syringe barrel, or a syringe plunger.

13. The method according to claim 1, wherein the mold comprises a removable insert, and wherein the removable insert comprises the surface with the at least one identification region, the method further comprising replacing the insert.

14. The method according to claim 1, wherein the at least one identification feature is at least one nanoscale identification feature.

15. The method according to claim 1, wherein the at least one identification feature is a covert identification feature.

16. A device comprising:
a pharmaceutical container portion mold configured to be used in injection molding, the mold comprising a surface with at least one identification region, the at least one identification region comprising at least one identification feature that has a lateral dimension of 100 microns or less.

17. The device according to claim 16, wherein the pharmaceutical container portion mold is a bottle mold, a vial cap mold, a syringe barrel mold, or a syringe plunger mold.

18. The device according to claim 16, wherein the surface is a surface configured to form an interior surface of a bottle, vial cap, or syringe.

19. The device according to claim 16, wherein the at least one identification feature is a nanoscale feature.

20. The device according to claim 16, wherein the at least one identification feature comprises an indentation in the surface.

21. The device according to claim 16, wherein the at least one identification feature comprises a protrusion on the surface.

22. The device according to claim 16, wherein the at least one identification region comprises a barcode.

23. The device according to claim 16, wherein the at least one identification region comprises an optically variable device.

24. The device according to claim 16, wherein the at least one identification region comprises a moiré pattern.

25. The device according to claim 16, wherein the mold comprises a removable insert, and wherein the removable insert comprises the surface with the at least one identification region.

26. The device according to claim 16, wherein the mold comprises a removable insert, and wherein the insert is disposed over a side wall or a bottom of the mold.

27. The device according to claim 16, wherein the mold further comprises a receptacle and a removable insert, wherein the removable insert comprises the surface with the at least one identification region, and wherein the insert is configured to be removably coupled to the receptacle.

28. A device comprising:
an insert for a pharmaceutical container portion mold configured to be used in injection molding, the insert comprising a surface with at least one identification region, the at least one identification region comprising at least one identification feature that has a lateral dimension of 100 microns or less.

29. The insert of claim 28, wherein the at least one identification feature is a nanoscale identification feature.

30. The insert according to claim 28, wherein the at lease one identification feature is a covert identification feature.

31. A method comprising:
disposing an adhesive or epoxy material over a pharmaceutical container portion, wherein the pharmaceutical container portion comprises a nanoscale feature;
curing the adhesive or epoxy material; and
removing the cured adhesive or epoxy material from the pharmaceutical container portion to thereby form a replica having a reverse feature of the nanoscale feature.

32. The method according to claim 31, further comprising inspecting the reverse feature using optical or scanning electron microscopy imaging.

33. The method according to claim 31, wherein the curing comprises UV or thermal curing.
